(19) United States
(12) Patent Application Publication
(10) Pub. No.: US 2005/0240574 A1
(43) Pub. Date: Oct. 27, 2005

(54) Pre-fetching resources based on a resource lookup query

(75) Inventors: James RH Challenger, Garrison, NY (US); Raymond B. Jennings III, Ossining, NY (US); Jason D. LaVoie, Mahopac, NY (US)

Correspondence Address: F. CHAU & ASSOCIATES, LLC, 130 WOODBURY ROAD, WOODBURY, NY, 11797, US

(73) Assignee: International Business Machines Corporation, Armonk, NY (US)

(21) Appl. No.: 10/833,202

(22) Filed: Apr. 27, 2004

(51) Int. Cl. G06F 17/30

(52) U.S. Cl. 707/3

(57) ABSTRACT

A method and apparatus are provided for pre-fetching resources based upon a query request to a resource lookup service. A monitoring application snoops for requests/replies from clients. Web content is pre-fetched via a web proxy based on the requests. Thus, the web content is made available to the client more efficiently.

### BACKGROUND OF THE INVENTION

1. Field of the Invention

The present invention relates to computer networks, and, more particularly, to pre-fetching resources based on a resource lookup query.

2. Description of the Related Art

Computer systems within a network environment typically need to locate remote resources. Such resources may include, but are not limited to, a web page, a database server, a remote application, and another computer system. A client computer typically deploys one or more resource lookup services (i.e., resource locators) within a computer network to serve other client computers and to serve as central points for locating resources that are requested by the client computer. As the locations of resources change, only the resource lookup service needs to be updated to reflect the new resource locations. Client computers may request any of a variety of information from any of a variety of resource lookup services, as contemplated by those skilled in the art. The corresponding resource lookup service fulfills the request with one or more resource lookup results. It is understood that the term “resource,” as used herein, includes tangible items (e.g., a web page) as well as lesser tangible items (e.g., a network address).

One prevalent example of a resource lookup service is the Domain Name System (DNS). DNS servers are generally used within Internet Protocol (IP) networks. The primary function of the DNS server is to translate between Internet host names and IP addresses. A client may make a resource lookup request to a DNS server by supplying an Internet host name that the client desires to locate. The DNS server may fulfill the resource lookup request with an IP address corresponding to the Internet host name. The DNS server may need to contact other DNS servers in a hierarchical tree to complete the search.

The client computer generally must wait for the resource lookup results to be returned from the DNS server and, as such, there may exist a delay between when the request is made and when the result is returned. This delay or latency can be short or long depending upon various attributes, such as the physical distance between the client and DNS server, how busy the DNS server is, and how long it takes the DNS server to find the requested data either locally or remote. In addition, the network topology may also contribute to this latency. The network medium between client and DNS server could be a slow dial-up or satellite link which will significantly increase the delay, especially if the network is congested. The end result is that the client computer cannot continue the current task until it receives the location data it is waiting for from the DNS server.

### SUMMARY OF THE INVENTION

In one aspect of the present invention, a method for pre-fetching resources based upon a query request to a resource lookup service is provided. The query request is implemented using at least one network packet. The method comprises monitoring the at least one network packet transmitted at least one of to and from the resource lookup service; and pre-fetching a resource related to the at least one network packet.

In a second aspect of the present invention, a method for verifying the location of a resource by monitoring at least one resource lookup request made by a requester of the resource to a resource lookup service is provided. The method comprises monitoring a plurality of resource lookup responses from the resource lookup service; matching at least one of the plurality of resource lookup responses to the requester; and maintaining a mapping of at least one location of the at least one of the plurality of resource lookup responses.

In a third aspect of the present invention, an apparatus for pre-fetching at least one resource based on at least one resource lookup request made to a resource lookup service is provided. The apparatus comprises means for transmitting at least one resource lookup request to a resource lookup service, the at least one resource lookup request implemented as at least one network packet, the at least one resource lookup request requesting at least one resource; means for monitoring a computer network for the at least one network packet; means for associating the at least one network packet with the at least one resource lookup request; means for retrieving the at least one resource associated with the at least one resource lookup request; and means for adding the at least one resource to a location where the requester can locate the at least one resource.

In a fourth aspect of the present invention, an apparatus for updating a configuration of at least one resource location is provided. The apparatus comprises means for monitoring at least one actual network location of at least one resource on a computer network; and means for updating the configuration based on the at least one actual location for future resource lookup requests to a resource lookup service.

In a fifth aspect of the present invention a program storage device readable by machine, tangibly embodying a program of instructions executable by the machine to perform method steps for pre-fetching a resource based upon a request made to a resource lookup service is provided. The method steps comprise monitoring at least one network packet; analyzing each of the at least one network packet for at least one query request for a resource lookup service; pre-fetching a resource based on criteria from the at least one query request and a configuration; and adding the resource to a location where the requester of the resource can locate the resource.

### BRIEF DESCRIPTION OF THE DRAWINGS

The invention may be understood by reference to the following description taken in conjunction with the accompanying drawings, in which like reference numerals identify like elements, and in which:

FIG. 1 depicts an exemplary network, in accordance with one embodiment of the present invention;

FIG. 2 depicts a portion of the exemplary network of FIG. 1, in accordance with one embodiment of the present invention;

FIG. 3 depicts an exemplary timing diagram, in accordance with one embodiment of the present invention; and

FIG. 4 depicts an alternate exemplary timing diagram, in accordance with one embodiment of the present invention.

### DETAILED DESCRIPTION OF PREFERRED EMBODIMENTS

Illustrative embodiments of the invention are described below. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims. It should be understood that the systems and methods described herein may be implemented in various forms of hardware, software, firmware, or a combination thereof.

During the “wait period” occurring while the client computer is waiting for the resource lookup results from the resource lookup service, a process that monitors a resource lookup service server can start retrieving one or more resources that the client is likely to request. These requested resources may be explicitly stated within the resource location request, inferred from past history, based on a configuration, or some combination thereof. By having the monitoring process trigger the pre-fetching of one or more resources, a client will likely see a decrease in latency when the client proceeds to request the resources.

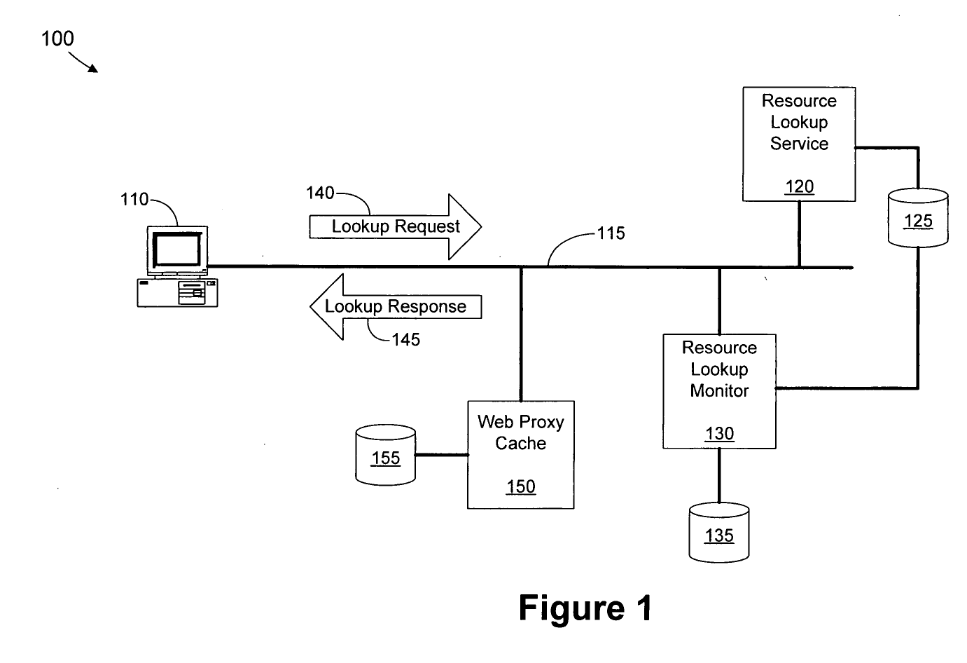

The present invention provides methods and apparatus for pre-fetching resources based upon a query to a lookup service. Referring now to FIG. 1, an exemplary network 100 is shown, in accordance with one embodiment of the present invention. A client computer 110 is operatively connected to a network 115. It is understood that any bi-directional network (e.g., the Internet) may be use as contemplated by those skilled in the art. It is understood that the present invention may utilize any number of client computers. A resource lookup service 120 and an associated resource location database 125 are operatively connected to the network 115. For only illustrative purposes, the resource lookup service 120 is a DNS server. However, it is understood that any of a variety of resource lookup services may be used, as contemplated by those skilled in the art.

A resource lookup monitor 130 and an associated configuration database 135 are attached to the network 115. The resource lookup monitor 130 monitors DNS requests 140 transmitted by the client 110 to the DNS server 120. When the resource lookup monitor 130 detects the DNS request 140, the resource lookup monitor 130 checks if the DNS server 120 has a corresponding IP address to service the DNS request 140. If so, the resource lookup monitor 130 triggers a web proxy cache 150 to obtain the likely content (e.g., web pages) from the IP address the client 110 is attempting to locate.

The configuration database 135 determines what the resource lookup monitor 130 will request to be pre-fetched. In this particular example, the resource lookup monitor 130 is configured to notify the web proxy cache 150 to retrieve the web content 155. If the DNS server 120 does not have the corresponding IP address to service the DNS request 140, the resource lookup monitor 130 will wait until a DNS response 145 is sent to the client 110 from the DNS server 120 before the resource lookup monitor 130 notifies the web proxy cache 150 to begin retrieving the web content 155. The resource lookup monitor 130 may further monitor what resources were requested as a result of the client 110 obtaining the DNS response 145 from the DNS server 120. For example, if the resources requested by the client 110 differ from what the resource lookup monitor 130 pre-fetches or requests the web proxy cache 150 to pre-fetch, the configuration database 135 may be updated to reflect this.

The configuration database 135 may be a set of statistics about each resource lookup request 140 and its corresponding desired resources. As shown in FIG. 1, the DNS request 140 does not contain information regarding the web content 155 (i.e., the actual resources) that the client 110 desires. However, it is understood that in other embodiments, the resources to be pre-fetched may be explicitly determined based upon a bit pattern within the resource lookup request 140, or based on the context of the resource lookup request 140, such as a resource lookup request 140 sent to an application server.

The number of resources to be pre-fetched may be specific to the type of resource lookup request 140 made to the resource lookup service 120, based on a configuration, or both. In addition, a resource that is pre-fetched may contain further resources that may also be pre-fetched.

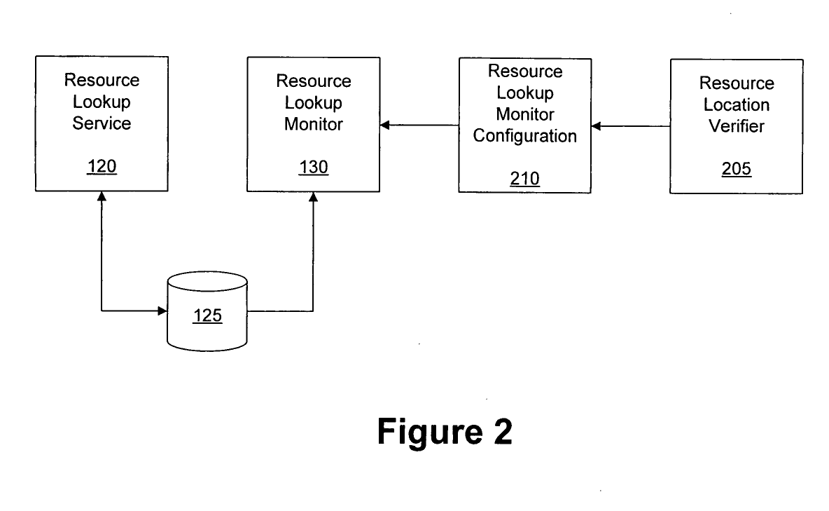

FIG. 2 illustrates a portion of the system 100 of FIG. 1, in accordance with one embodiment of the present invention. As previously described, the resource lookup monitor 130 monitors resource lookup requests (not shown) being made to as well as resource lookup responses (not shown) from the resource lookup service 120. The resource lookup monitor 130 may be integrated with the resource lookup service 120 or a separate standalone process. The resource lookup service 120 can read from and write to the resource location database 125. In the case where it is integrated with the resource lookup service 120, the resource lookup monitor 130 can only read from the resource location database 125. A resource location verifier 205 monitors the actual desired resources and updates a resource lookup monitor configuration 210 based on this information. It is understood that any of the blocks illustrated in FIG. 2 may be integrated in a single process or multiple processes. In addition, such processes may be executed on a single machine or a plurality of machines operatively connected to the network.

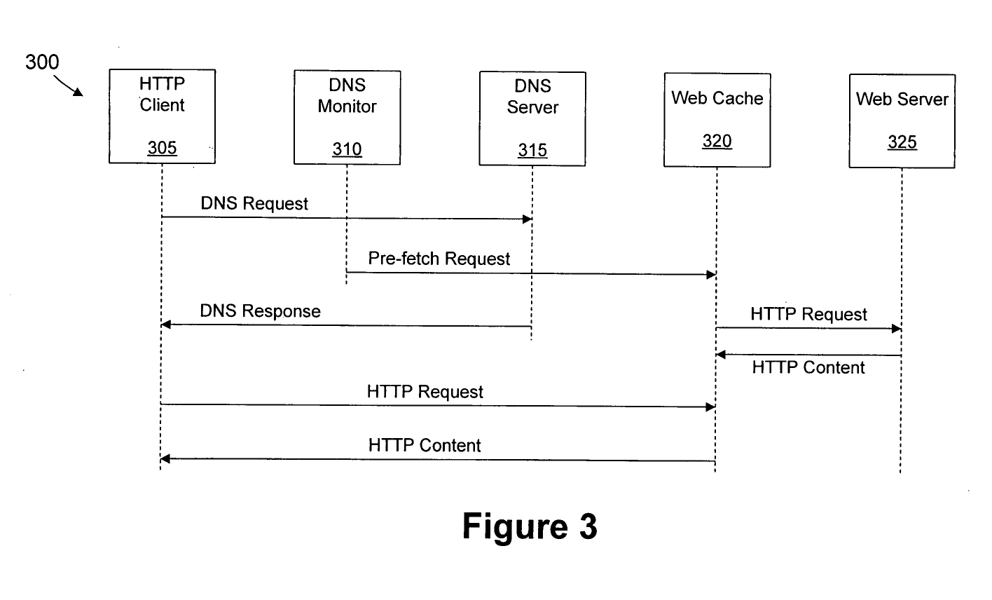

Referring now to FIG. 3, an exemplary timing diagram 300 is illustrated, in accordance with one embodiment of the present invention. The timing diagram 300 includes an HTTP client 305, a DNS monitor 310, a DNS server 315, a web cache 320, and a web server 325, each of which are operatively connected on a network (not shown). A DNS request is made by the HTTP client 305 to the DNS server 315. The DNS monitor 310 sees the DNS request and sends a pre-fetch request to the web cache 320, which causes the web cache 320 to send an HTTP request to the web server 325. The web server 325 replies back to the web cache 320 with the HTTP content. After the DNS monitor 310 requests the web cache 320 to send an HTTP request to the web server 325, the DNS server 315 replies back to the HTTP client 305 with a DNS response. After the HTTP client 305 receives the DNS response from the DNS server 315, the HTTP client 305 sends an HTTP request to the web cache 320. As illustrated in FIG. 3, the web cache 320 received the HTTP content from the web server 325 prior to the HTTP client 305 sending the HTTP request to the web cache 320. The web cache 320 may (1) be in the process of sending an HTTP request to the web server 325, (2) be waiting for the HTTP content from the web server 325, or (3) have already received the HTTP content from the web server 325. At such a time when the HTTP content has been received by the web cache 320, a copy of the HTTP content will be made available to the HTTP client 305.

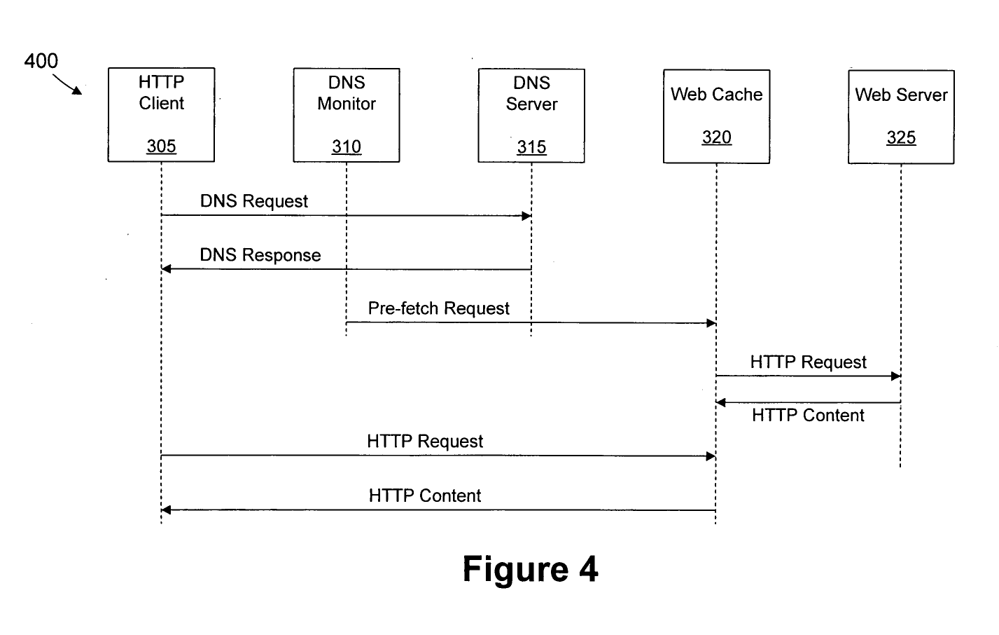

Referring now to FIG. 4, an alternate exemplary timing diagram 400 is illustrated, in accordance with one embodiment of the present invention. The DNS server 315 does not have the IP address when the DNS request is submitted by the HTTP client 305. The timing diagram 400 shows that the DNS monitor 310 must wait for the DNS server 315 to obtain the DNS response from some other external source. In addition, if the DNS server 315 and DNS monitor 310 are not sharing the same physical cache or resource location database 125, the DNS monitor 310 will have to wait for the DNS response from the DNS server 315. After the DNS server 315 obtains the DNS response, the response is returned to the HTTP client 305. When the DNS response is sent to the HTTP client 305, the DNS monitor 310 will see the DNS response in transit and send the pre-fetch request to the web cache. At some point, the HTTP client 305 will send an HTTP request to the web cache 320. The web cache 320 may (1) be in the process of sending an HTTP request to the web server 325, (2) be waiting for the HTTP content from the web server 325, or (3) have already received the HTTP content from the web server 325. At such a time when the HTTP content has been received by the web cache 320, a copy of the HTTP content will be made available to the HTTP client 305.

It is appreciated that the timing diagrams of FIGS. 3 and 4 are only exemplary, and other timing configurations may be contemplated by those skilled in the art. For example, the DNS server 315 may be independent of the DNS monitor 310.

An apparatus implementing the present invention for pre-fetching resources based upon a query to a resource lookup service can be implemented as one or more computer processes running on one or more computer machines. The apparatus may include a means for monitoring requests destined for or results returned from a resource lookup service. The apparatus may include a means for requesting and retrieving resources and making said resources available to the requester. The apparatus may further include a means for monitoring the location of the actual resources being requested by the client and updating the configuration if the actual resources being requested by the client are determined to be different than what the monitor was configured to pre-fetch.

The particular embodiments disclosed above are illustrative only, as the invention may be modified and practiced in different but equivalent manners apparent to those skilled in the art having the benefit of the teachings herein. Furthermore, no limitations are intended to the details of design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for pre-fetching resources based upon a query request to a resource lookup service, the query request being implemented using at least one network packet, the method comprising:
monitoring the at least one network packet transmitted at least one of to and from the resource lookup service; and
pre-fetching a resource related to the at least one network packet.

2. The method of claim 1, wherein the resource lookup service comprises a network-attached application that provides a network location of the resource in response to the query request.

3. The method of claim 2, wherein the network location comprises at least one of a host name, an application name, an IP (Internet Protocol) address, a Globally Unique Identifier, and an application specific identifier.

4. The method of claim 1, wherein, the resource lookup service comprises at least one of a DNS (Domain Name System) server, a LDAP (Lightweight Directory Access Protocol) server, a Corba Naming Service, a NDS, and a JNDI (Java Naming and Directory Interface) object database.

5. The method of claim 1, wherein the step of monitoring the at least one network packet comprises determining if the at least one network packet contain a query request.

6. The method of claim 1, further comprising adding the resource to a network location where the resource can be located.

7. The method of claim 1, wherein pre-fetching a resource related to the at least one network packet comprises pre-fetching the resource related to the at least one network packet from a location one of determined and partially determined by the at least one network packet.

8. The method of claim 7, further comprising further determining the location by a configuration.

9. The method of claim 1, wherein pre-fetching a resource related to the at least one network packet comprises pre-fetching the resource specified within the at least one network packet.

10. The method of claim 1, wherein pre-fetching a resource related to the at least one network packet comprises pre-fetching the resource determined based upon a bit pattern within the at least network packet.

11. The method of claim 1, wherein pre-fetching a resource related to the at least one network packet comprises pre-fetching the resource determined based upon the context of the at least one network packet.

12. The method of claim 1, wherein pre-fetching a resource related to the at least one network packet comprises pre-fetching the resource containing the location of additional resources to request.

13. A method for verifying the location of a resource by monitoring at least one resource lookup request made by a requester of the resource to a resource lookup service, the method comprising:
monitoring a plurality of resource lookup responses from the resource lookup service;
matching at least one of the plurality of resource lookup responses to the requester; and
maintaining a mapping of at least one location of the at least one of the plurality of resource lookup responses.

14. The method of claim 13, further comprising adding the resource to a location where the requester can locate the resource.

15. An apparatus for pre-fetching at least one resource based on at least one resource lookup request made to a resource lookup service, the apparatus comprising:
means for transmitting at least one resource lookup request to a resource lookup service, the at least one resource lookup request implemented as at least one network packet, the at least one resource lookup request requesting at least one resource;
means for monitoring a computer network for the at least one network packet;
means for associating the at least one network packet with the at least one resource lookup request;
means for retrieving the at least one resource associated with at least one resource lookup request; and
means for adding the at least one resource to a location where the requester can locate the at least one resource.

16. The apparatus of claim 15, wherein the means for associating the at least one network packet with the at least one resource lookup request comprises a means for locating a bit pattern within the at least one network packet.

17. The apparatus of claim 15, wherein the means for transmitting at least one resource lookup request to a resource lookup service comprises means for transmitting at least one remote resource lookup request to a resource lookup service, the at least one remote resource lookup request requesting at least one remote resource located at a remote location.

18. The apparatus of claim 15, wherein the means for retrieving the at least one resource associated with the at least one resource lookup request comprises retrieving at least one remote resource located at a remote location.

19. An apparatus for updating a configuration of at least one resource location, the apparatus comprising:
means for monitoring at least one actual network location of at least one resource on a computer network; and
means for updating the configuration based on the at least one actual location for future resource lookup requests to a resource lookup service.

20. An apparatus as recited in claim 20, further comprising monitoring resource requests to update a configuration.

21. A program storage device readable by machine, tangibly embodying a program of instructions executable by the machine to perform method steps for a resource to be pre-fetched based upon a request made to a resource lookup service, the method steps comprising:
transmitting at least one resource lookup request to a resource lookup service, the at least one resource lookup request implemented as at least one network packet, the at least one resource lookup request requesting at least one resource;
monitoring a computer network for the at least one network packet;
associating the at least one network packet with the at least one resource lookup request;
retrieving the at least one resource associated with the at least one resource lookup request; and
adding the at least one resource to a location where the requester can locate the at least one resource.

22. The program storage device as recited in claim 21, the method further comprising updating a configuration of the location based on the actual resource requested by a requester.
